(19) United States
(12) Patent Application Publication
(10) Pub. No.: US 2013/0050419 A1
(43) Pub. Date: Feb. 28, 2013

(54) VIDEO PROCESSING APPARATUS AND VIDEO PROCESSING METHOD

(71) Applicants: Atsushi Nakamura, Tokyo (JP); Shinzo Matsubara, Tokyo (JP); Yutaka Irie, Yokohama-Shi (JP)

(72) Inventors: Atsushi Nakamura, Tokyo (JP); Shinzo Matsubara, Tokyo (JP); Yutaka Irie, Yokohama-Shi (JP)

(73) Assignee: KABUSHIKI KAISHA TOSHIBA, TOKYO (JP)

(21) Appl. No.: 13/406,103

(22) Filed: Feb. 27, 2012

(30) Foreign Application Priority Data
Aug. 31, 2011 (JP) 2011-189521

(51) Int. Cl. H04N 13/04

(52) U.S. Cl. 348/43; 348/54; 348/E13.026; 348/E13.062

(57) ABSTRACT

According to one embodiment, a video processing apparatus includes a viewer position detector, a viewing area information calculator, and a viewing area controller. The viewer position detector is configured to detect a position of a viewer using an image taken by a camera. The viewing area information calculator is configured to calculate a control parameter so as to set a viewing area, in which a plurality of parallax images displayed on a display are viewed as a stereoscopic image, at an area depending on the position of the viewer. The viewing area controller is configured to set the viewing area according to the control parameter in synchronization with a start of displaying a stereoscopic image, and then, keep the set viewing area until receiving an indication for adjusting the viewing area.

### CROSS REFERENCE TO RELATED APPLICATIONS

This application is based upon and claims the benefit of priority from the prior Japanese Patent Application No. 2011-189521, filed on Aug. 31, 2011, the entire contents of which are incorporated herein by reference.

### FIELD

Embodiments described herein relate generally to a video processing apparatus and a video processing method.

### BACKGROUND

In recent years, a stereoscopic video display apparatus (so-called autostereoscopic television) has been widely used. A viewer can see the video displayed on the autostereoscopic television stereoscopically without using special glasses. This stereoscopic video display apparatus displays a plurality of images with different viewpoints. Then, the output directions of light rays of those images are controlled by, for example, a parallax barrier, a lenticular lens or the like, and guided to both eyes of the viewer. When a viewer's position is appropriate, the viewer sees different parallax images respectively with the right and left eyes, thereby recognizing the video as stereoscopic video.

However, there has been a problem with the autostereoscopic television in that video cannot be stereoscopically viewed depending on the viewer's position.

### BRIEF DESCRIPTION OF THE DRAWINGS

FIG. 1 is an external view of a video display apparatus 100 having the viewing area control function.

FIG. 2 is a block diagram showing a schematic configuration of the video display apparatus 100.

FIGS. 3A to 3C are views of each of the liquid crystal panel 1 and the lenticular lens 2 seen from above.

FIGS. 4A to 4E are views showing an example of the technique for calculating viewing area information.

FIG. 5 is a view showing an example of a remote controller 20 to transmit a signal to the video display apparatus 100.

FIGS. 6A and 6B are views showing an example of the OSD for setting the viewing area control mode.

FIG. 7 is a flowchart showing an example of processing operations of the controller 10 of the video display apparatus 100 according to the first embodiment.

FIG. 8 is a flowchart showing an example of processing operations of the controller 10 of the video display apparatus 100 according to the second embodiment.

FIG. 9 is a flowchart showing an example of processing operations of the controller 10 of the video display apparatus 100 according to the third embodiment.

FIG. 10 is a block diagram showing a schematic configuration of a video display apparatus 100a according to the fourth embodiment.

FIG. 11 is a flowchart showing an example of processing operations of the controller 10a of the video display apparatus 100a according to the fourth embodiment.

FIG. 12 is a block diagram showing a schematic configuration of a video display apparatus 100b according to the fifth embodiment.

FIG. 13 is a flowchart showing an example of processing operations of the controller 10b of the video display apparatus 100b according to the fifth embodiment.

FIG. 14 is a block diagram showing a schematic configuration of a video display apparatus 100c according to a sixth embodiment.

FIG. 15 is a flowchart showing an example of processing operations of the controller 10c of the video display apparatus 100c according to the sixth embodiment.

FIG. 16 is a flowchart showing an example of processing operations of the controller 10c of the video display apparatus 100c according to the seventh embodiment.

FIG. 17 is a diagram showing an example of the relation between a category of contents and a position of the viewing area, kept in the control information keeping module 18.

FIG. 18 is a flowchart showing an example of processing operations of the controller 10c of the video display apparatus 100c according to the eighth embodiment.

FIG. 19 is a block diagram showing a schematic configuration of a video display apparatus 100′ as a modification of FIG. 2.

### DETAILED DESCRIPTION

In general, according to one embodiment, a video processing apparatus includes a viewer position detector, a viewing area information calculator, and a viewing area controller. The viewer position detector is configured to detect a position of a viewer using an image taken by a camera. The viewing area information calculator is configured to calculate a control parameter so as to set a viewing area, in which a plurality of parallax images displayed on a display are viewed as a stereoscopic image, at an area depending on the position of the viewer. The viewing area controller is configured to set the viewing area according to the control parameter in synchronization with a start of displaying a stereoscopic image, and then, keep the set viewing area until receiving an indication for adjusting the viewing area.

Hereinafter, embodiments will be specifically described with reference to drawings. First, a brief overview of a viewing area control function will be described.

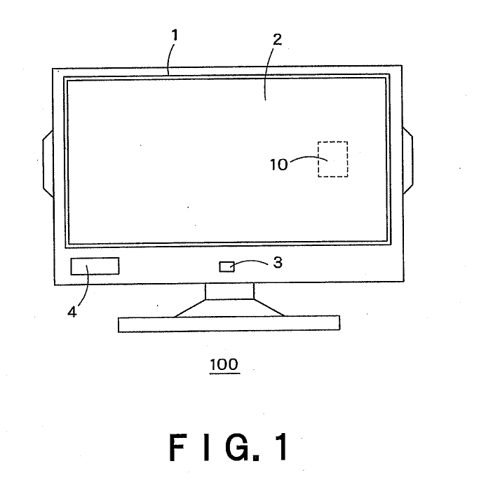

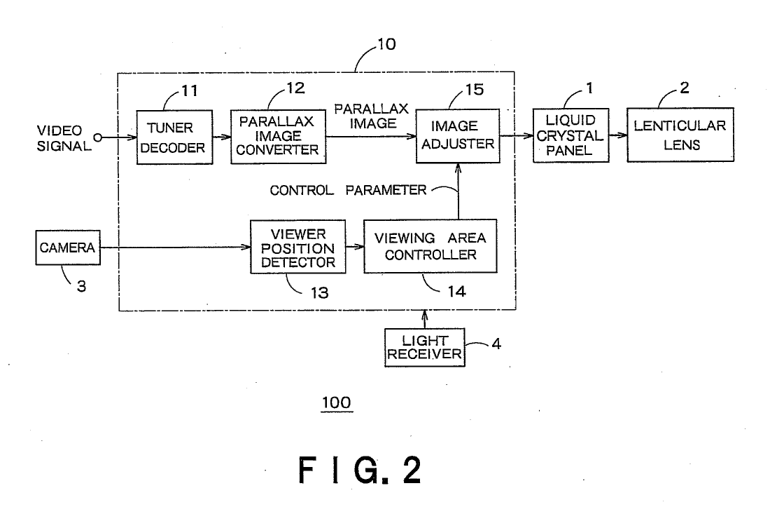

FIG. 1 is an external view of a video display apparatus 100 having the viewing area control function, and FIG. 2 is a block diagram showing a schematic configuration thereof. The video display apparatus 100 has a liquid crystal panel 1, a lenticular lens 2, a camera 3, a light receiver 4 and a controller 10.

The liquid crystal panel (display) 1 is, for example, a 55-inch size panel, where 11520 (=1280*9) pixels are arranged in a horizontal direction and 720 pixels are arranged in a vertical direction. Further, three sub-pixels, namely an R sub-pixel, a G sub-pixel and a B sub-pixel are formed in the vertical direction inside each pixel. The liquid crystal panel 1 is irradiated with light from a backlight (not shown) provided on a back surface thereof. Each pixel allows passage of light with a luminance depending on a parallax image signal (described later) provided from the controller 10.

The lenticular lens (apertural area controller) 2 has a plurality of convex portions arranged along the horizontal direction of the liquid crystal panel 1, and the number thereof is one ninth of the number of pixels in the horizontal direction of the liquid crystal panel 1. Then, the lenticular lens 2 is attached on the surface of the liquid crystal panel 1 such that one convex portion corresponds to nine pixels arranged in the horizontal direction. The light having passed through each pixel is output from the vicinity of the top of the convex portion in a particular direction with directivity.

The liquid crystal panel 1 of the present embodiment is capable of displaying stereoscopic video by a multi-parallax system (integral imaging system) with not less than three parallaxes or a two-parallax system, and other than those, it is also capable of displaying normal two-dimensional video.

In the following description, an example will be explained where nine pixels are provided corresponding to each convex portion of the lenticular lens 2 so that a multi-parallax system with nine parallaxes can be adopted. In the multi-parallax system, first to nine parallax images are respectively displayed in the nine pixels corresponding to each convex portion. The first to nine parallax images are images in which an object is viewed respectively from nine viewpoints arrayed along the horizontal direction of the liquid crystal panel 1. The viewer can respectively view one parallax image among the first to nine parallax images with the left eye and another one parallax image with the right eye via the lenticular lens 2, so as to stereoscopically view the video. According to the multi-parallax system, as the number of the parallax is increased, the viewing area can be wider. The viewing area refers to an area in which video can be stereoscopically viewed when the liquid crystal panel 1 is viewed from its front.

On the other hand, in the two-parallax system, parallax images for a right eye are displayed in four pixels and parallax images for a left eye are displayed in the other five pixels among the nine pixels corresponding to each convex portion. The parallax images for a left eye and a right eye are images obtained by viewing the object from a left-side viewpoint and a right-side viewpoint respectively among the two viewpoints arrayed in the horizontal direction. The viewer can view the parallax image for a left eye with the left eye and the parallax image for a right eye with the right eye via the lenticular lens 2, so as to stereoscopically view the video. According to the two-parallax system, a three-dimensional appearance of displayed video is easier to obtain than in the multi-parallax system, but a viewing area is narrower than that in the multi-parallax system.

It is to be noted that the liquid crystal panel 1 can also display a two-dimensional image by display an identical image in the nine pixels corresponding to each convex portion.

Further, in the present embodiment, the viewing area is made variably controllable according to a relative positional relation between the convex portion of the lenticular lens 2 and a displayed parallax image, namely how the parallax image is to be displayed in the nine pixels corresponding to each convex portion. Hereinafter, the control of the viewing area will be described by taking the multi-parallax system as an example.

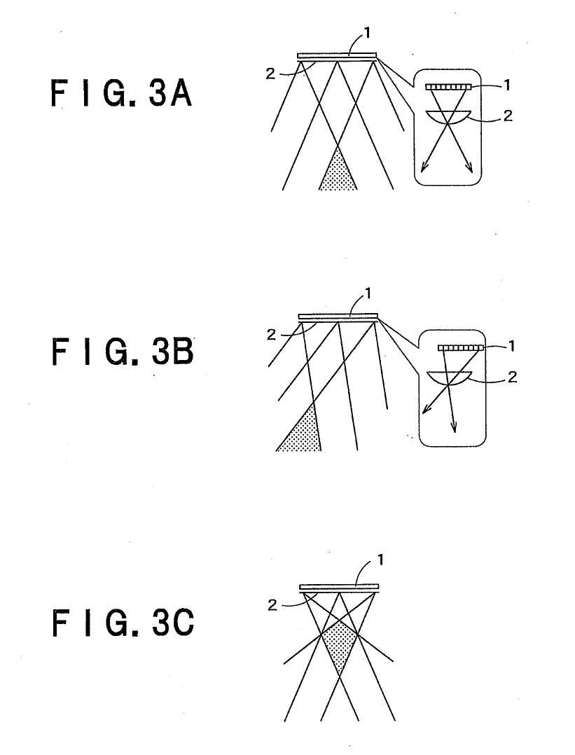

FIG. 3 is a view of part of each of the liquid crystal panel 1 and the lenticular lens 2 seen from above. A shaded area in the figure indicates a viewing area, and video can be viewed stereoscopically by viewing the liquid crystal panel 1 from the viewing area. The other areas are areas where a reverse view or a crosstalk is generated, and it is difficult to view the video stereoscopically therefrom.

FIG. 3 shows a state where the viewing area changes depending on a relative positional relation between the liquid crystal panel 1 and the lenticular lens 2, more specifically, a distance between the liquid crystal panel 1 and the lenticular lens 2 or a horizontal shift amount between the liquid crystal panel 1 and the lenticular lens 2.

In practice, because the lenticular lens 2 is highly accurately positioned and attached on the liquid crystal panel 1, it is difficult to physically change the relative position between the liquid crystal panel 1 and the lenticular lens 2.

Accordingly, in the present embodiment, display positions of the first to nine parallax images displayed in the respective pixels of the liquid crystal panel 1 are shifted, to apparently change the relative positional relation between the liquid crystal panel 1 and the lenticular lens 2 so as to adjust the viewing area.

For example, as compared with the case of the first to nine parallax images being respectively displayed in the nine pixels corresponding to each convex portion (FIG. 3A), the viewing area moves to the left side when the parallax images are shifted to the right side and displayed (FIG. 3B). On the contrary, the viewing area moves to the right side when the parallax images are shifted to the left side and displayed.

Further, the viewing area moves in a direction approaching the liquid crystal panel 1 when the parallax image is not shifted near the center in the horizontal direction and the parallax image is shifted outward to a larger degree on the more external side of the liquid crystal panel 1 (FIG. 3C). It is to be noted that pixels between the shifted parallax image and the non-shifted parallax image, or pixels between the parallax images shifted by different amount, may be interpolated as appropriate according to peripheral pixels. Further, as opposed to FIG. 3C, the viewing area moves in a direction away from the liquid crystal panel 1 when the parallax image is not shifted near the center in the horizontal direction and the parallax image is shifted to the center side to a larger degree on the more external side of the liquid crystal panel 1.

As thus described, by shifting and displaying the whole or part of the parallax images, the viewing area moves in a horizontal or front-back direction with respect to the liquid crystal panel 1. In FIG. 3, only one viewing area is shown for the sake of simplifying the description, but in practice, a plurality of viewing areas are present and these move in conjunction with one another. The viewing area is controlled by the controller 10 in FIG. 2 which will be described later.

Returning to FIG. 1, the camera 3 is installed near the lower center of the liquid crystal panel 1 at a predetermined elevation angle, and photographs video of the front of the liquid crystal panel 1 in a predetermined range. The photographed video is provided to the controller 10 and used for detecting information on the viewer, such as a position of the viewer, a face of the viewer, and the like. The camera 3 may take either a motion image or a still image.

The light receiver 4 is, for example, provided on the lower left side of the liquid crystal panel 1. Then, the light receiver 4 receives an infrared signal transmitted from a remote controller used by the viewer. This infrared signal includes a signal indicative of whether stereoscopic video is displayed or two-dimensional video is displayed, whether the multi-parallax system is taken or the two-parallax system is taken in the case of displaying the stereoscopic video, whether or not to control the viewing area, or the like.

Next, a detail of configuration components of the controller 10 will be described. As shown in FIG. 2, the controller 10 has a tuner decoder 11, a parallax image converter 12, a viewer position detector 13, a viewing area information calculator 14, and an image adjuster 15. The controller 10 is implemented, for example, as one IC (Integrated Circuit) and arranged on the back side of the liquid crystal panel 1. Naturally, part of the controller 10 may be implemented by software.

The tuner decoder (receiver) 11 receives an input broadcast wave, tunes (selects a channel), and decodes a coded video signal. In a case where a data broadcasting signal such as an electronic program guide (EPG) is superimposed on the broadcast wave, the tuner decoder 11 extracts this signal. Alternatively, it is also possible that the tuner decoder 11 receives not a broadcast wave but a coded video signal from video output equipment such as an optical disk reproducing apparatus or a personal computer, and decodes this signal. The decoded signal is also referred to as a baseband video signal, and provided to the parallax image converter 12. It should be noted that in the case of the video display apparatus 100 not receiving a broadcast wave but exclusively displaying a video signal received from the image output equipment, a decoder having a decoding function may be simply provided in place of the tuner decoder 11.

The video signal received by the tuner decoder 11 may be a two-dimensional video signal or may be a three-dimensional video signal including images for a left eye and a right eye in a frame packing (FP) format, a side-by-side (SBS) format, a top-and-bottom (TAB) format, or the like. Further, the video signal may be a three-dimensional video signal including images of equal to or more than three parallaxes.

In order to display stereoscopic video, the parallax image converter 12 converts a baseband video signal to a plurality of parallax image signals and provide them to the image adjuster 15. A processing of the parallax image converter 12 varies depending on which system, the multi-parallax system or the two-parallax system, is adopted. Further, the processing of the parallax image converter 12 also varies depending on whether the baseband video signal is a two-dimensional video signal or a three-dimensional video signal.

In the case of adopting the two-parallax system, the parallax image converter 12 generates parallax image signals for a left eye and a right eye corresponding to parallax images for a left eye and a right eye, respectively. More specifically, the following will be performed.

When the two-parallax system is adopted and a three-dimensional video signal including images for a left eye and a right eye is input, the parallax image converter 12 generates parallax image signals for a left eye and a right eye in a format which can be displayed on the liquid crystal panel 1. Further, when a three-dimensional video signal including equal to or more than three images is input, the parallax image converter 12, for example, uses arbitrary two images among them to generate parallax image signals for a left eye and a right eye.

As opposed to this, in a case where the two-parallax system is adopted and a two-dimensional video signal including no parallax information is input, the parallax image converter 12 generates parallax images for a left eye and a right eye based on a depth value of each pixel in the video signal. The depth value is a value indicating that to what extent each pixel is displayed so as to be viewed in front of or in the back of the liquid crystal panel 1. The depth value may be previously added to a video signal, or may be generated by performing motion detection, identification of a composition, detection of a human's face, or the like. In the parallax image for a left eye, a pixel viewed in front needs to be shifted to the right side of a pixel viewed in the back, and to be displayed. For this reason, the parallax image converter 12 performs processing of shifting the pixel viewed in front to the right side in the video signal, to generate a parallax image signal for a left eye. The larger the depth value is, the larger the shift amount is.

Meanwhile, in the case of adopting the multi-parallax system, the parallax image converter 12 generates first to nine parallax image signals corresponding to first to nine parallax images, respectively. More specifically, the following will be performed.

When the multi-parallax system is adopted and a two-dimensional video signal or a three-dimensional video signal including less than nine parallaxes is input, the parallax image converter 12 generates first to nine parallax image signals based on depth information similar to generating parallax image signals for a left eye and a right eye from a two-dimensional video signal.

When the multi-parallax system is adopted and a three-dimensional video signal including nine parallaxes is input, the parallax image converter 12 generates first to nine parallax image signals using the video signal.

The viewer position detector 13 detects a position of the viewer by using the video taken by the camera 3, and provides that position information to the viewing area information calculator 14.

The position information of the viewer is represented, for example, as a position on an X-axis (horizontal direction), a Y-axis (vertical direction) and a Z-axis (orthogonal direction to the liquid crystal panel 1) with the center of the liquid crystal panel 1 regarded as an original point. More specifically, the viewer position detector 13 first detects a face from the video taken by the camera 3, to recognize the viewer. Subsequently, the viewer position detector 13 detects positions on the X-axis and the Y-axis from a position of the face in the video, and detects a position on the Z-axis from a size of the face. When a plurality of viewers is present, the viewer position detector 13 may detect positions of the predetermined number (e.g., ten) of viewers. In this case, when the number of detected faces is larger than ten, for example, positions of ten viewers are detected in an increasing order of a distance from the liquid crystal panel 1, namely an increasing order of the position on the Z-axis.

The viewing area information calculator 14 calculates a control parameter (e.g., a shift length of a parallax image described in FIG. 3) so that the viewing area is appropriately set according to the detected position information of the viewer, and provides the control parameter to the image adjuster 15.

The technique for detecting the viewer's position by the position detector 13 is not particularly restricted. The camera 3 may be an infrared camera, and the viewer's position may be detected by a sound wave.

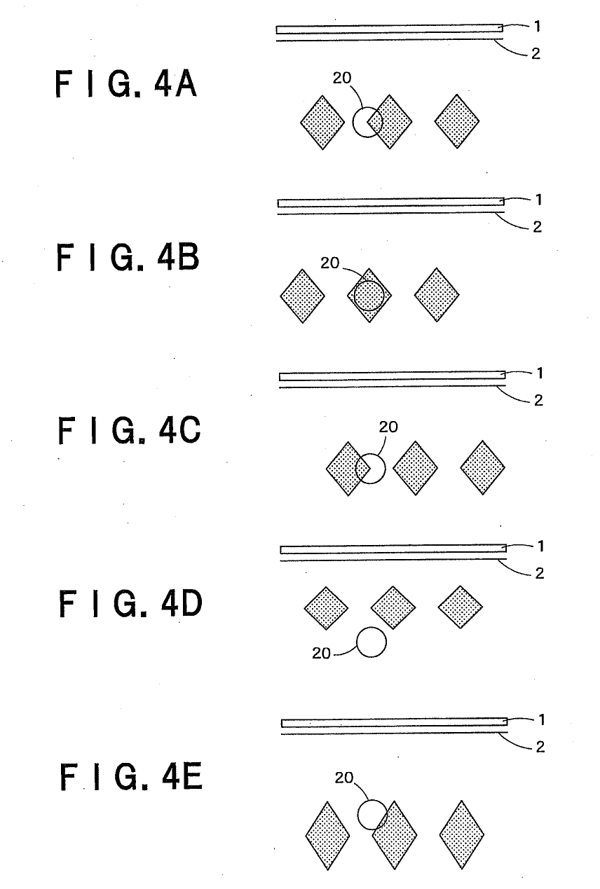

FIG. 4 is a view showing an example of the technique for calculating viewing area information. The viewing area information calculator 14 previously defines several settable patterns of viewing area. Then, the viewing area information calculator 14 calculates an overlapping area between the viewing area and the detected viewer, and determines a viewing area with the calculated area being maximal as an appropriate viewing area. In the example of FIG. 4, an overlapping area between a viewer 20 and the viewing area is maximal in FIG. 4B where the viewing area is set on the left side with respect to the liquid crystal panel 1 among five patterns of viewing area (shaded areas) in FIGS. 4A to 4E which have been previously defined. Therefore, the viewing area information calculator 14 determines the pattern of viewing area in FIG. 4B as an appropriate viewing area. In this case, a control parameter for displaying the parallax image in the pattern in FIG. 4B is provided to the image adjuster 15 in FIG. 2.

More specifically, in order to set a desired viewing area, the viewing area information calculator 14 may use a viewing area database associating the control parameter with a viewing area set by that control parameter. The viewing area information calculator 14 can find a viewing area capable of keeping the selected viewers by searching the viewing area database.

For controlling the viewing area, the image adjuster (viewing area controller) 15 performs adjustment such as shift or interpolation of a parallax image signal according to the calculated control parameter, and provides the adjusted signal to the liquid crystal panel 1. The liquid crystal panel 1 displays an image corresponding to the adjusted parallax image signal.

By controlling the viewing area using the automatically detected viewer's position constantly as described above, an appropriate viewing area is set for the viewer in real time. However, even in the case of the viewer standing still and viewing the video, when another person moves in front of the video display apparatus 100, the viewing area may move in response to the moving person. In this case, it is difficult for the viewer standing still to view the video.

Therefore, as a viewing area control mode, either an “auto tracking mode” for constantly detecting the viewer's position and automatically controlling the viewing area or a “manual tracking mode” for controlling the viewing area with specific timing (mentioned later) is made selectable by the viewer. This selection can be made by using a remote controller, for example.

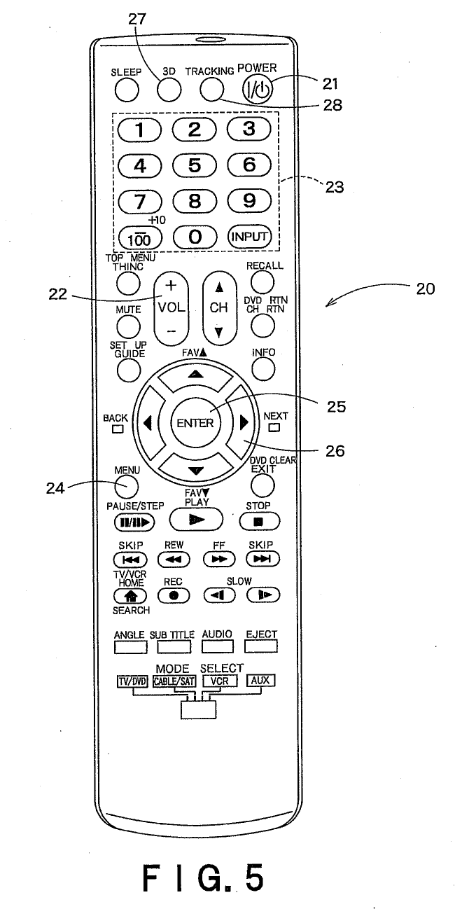

FIG. 5 is a view showing an example of a remote controller 20 to transmit a signal to the video display apparatus 100. The remote controller 20 is has a power key 21, a volume key 22, a channel selection key 23, a menu key 24, an enter key 25, a cursor key 26, a 3D key 27, a tracking key 28, and the like. For example, when the 3D key 27 is pushed down, a signal for directing displaying stereoscopic video on the liquid crystal panel 1 is generated regardless of whether an input video signal is a two-dimensional video signal or a three-dimensional video signal.

When the menu key 24, the cursor key 26, the enter key 25 and the like are operated to select a viewing area control mode setting menu, an OSD (On Screen Display) for setting a viewing area control mode is displayed.

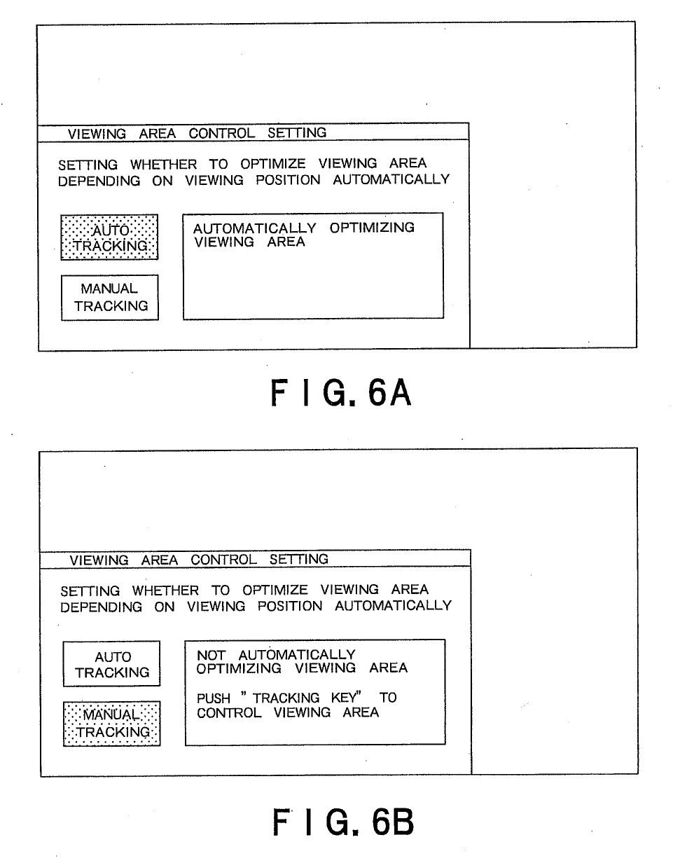

FIG. 6 is a view showing an example of the OSD for setting the viewing area control mode. FIG. 6A shows a state where a cursor is on the auto tracking mode, and for example, a description that “automatically controlling viewing area” may be displayed. When the enter key 25 is pushed down in this state, the mode is set to the auto tracking mode. On the other hand, FIG. 6B shows a state where the cursor is on the manual tracking mode, and for example, a description that “not automatically controlling viewing area” may be displayed. When the enter key 25 is pushed down in this state, the mode is set to the manual tracking mode.

It is to be noted that the remote controller 20 is not necessarily used, and an equivalent button to this may, for example, be provided adjacently to the light receiver 4 or the camera 3 of the video display apparatus 100. Further, when the video display apparatus 100 has a touch panel function, such as the case of the video display apparatus 100 being a tablet terminal, a button may be displayed on the liquid crystal panel 1 to allow the user to perform setting.

First to third embodiments described hereinafter relate to the manual tracking mode. The manual tracking mode is to control the viewing area with specific timing. In the first and second embodiments, examples will be shown where that timing is the display start of stereoscopic video, and in the third embodiment, an example will be shown where that timing is pushing down of the tracking key 28 of the remote controller 20 during displaying the stereoscopic video. It is to be noted that the following embodiments can be applied even in the case of adopting either the two-parallax system or the multi-parallax system.

### First Embodiment

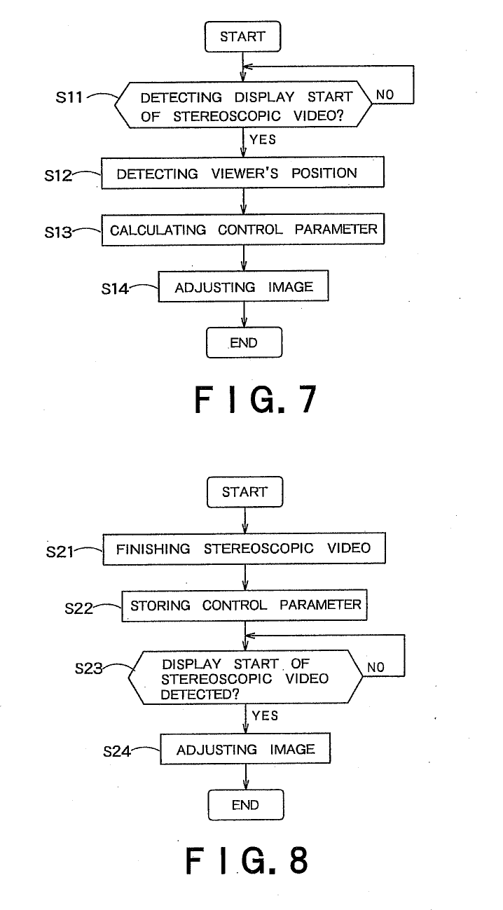

FIG. 7 is a flowchart showing an example of processing operations of the controller 10 of the video display apparatus 100 according to a first embodiment. Hereinafter, it will be taken into consideration that the mode has previously been set to a position capture mode.

First, when the light receiver 4 receives an infrared signal indicating that the viewer has pushed down the 3D key 27 of the remote controller 20 or when a video signal is switched from a two-dimensional video signal to a three-dimensional video signal, the viewing area information calculator 14 detects the display-start of stereoscopic video (Step S11: YES). In response to the display-start of the stereoscopic video, the viewer position detector 13 detects a viewer's position by using the video taken by the camera 3 (Step S12). The viewing area information calculator 14 calculates a control parameter such that the viewing area is set at the detected viewer's position (Step S13). Then, the image adjuster 15 adjusts parallax image signals according to the control parameter (Step S14), and a parallax image corresponding to the adjusted parallax image signals is displayed on the liquid crystal panel 1.

Thereby, the viewing area is set in the viewer's position, and the viewer can stereoscopically view the parallax image displayed on the liquid crystal panel 1 via the lenticular lens 2. On the manual tracking mode, the set viewing area is kept in the same position until receipt of a direction to adjust the viewing area from the viewer.

Note that, although an example is shown where the viewer's position is detected according to the display-start of the stereoscopic video (Step S12) in FIG. 7, the viewing area may be set in synchronization with the display-start of the stereoscopic video. For example, the viewer's position may be constantly detected, and the control parameter may be calculated according to the display-start of the stereoscopic video, or the viewer's position may be constantly detected and the control parameter may be constantly calculated, and the image is adjusted according to the display-start of the stereoscopic video.

Further, the viewer position detector 13 may not be able to recognize the viewer in some cases, for example, in a case where a viewing field of the camera 3 is disturbed by a certain obstacle, where the viewer's face is located outside a video-taking range of the camera 3, or where the viewer's face is difficult to be detected due to the viewer wearing a mask or looking down even with the face located within the video-taking range of the camera 3, and so on. In this case, if there is a record that the viewer has been detected before the display-start of the stereoscopic video three to four seconds ago for example, the viewing area may be set in the viewer's position at that time. When there is no record, a warning indicating that the viewer's position cannot be recognized may be displayed.

Further, in a case where the viewer is excessively close to the liquid crystal panel 1 when the viewer position detector 13 detects the viewer's position, for example in a case where the distance between the viewer and the liquid crystal panel 1 is less than 3H (H is a height of the liquid crystal panel 1), a warning indicating that the viewer is urged to be away from the screen may be displayed because a three-dimensional appearance is difficult to obtain due to such a distance.

As described above, in the first embodiment, the viewing area is controlled so as to be set at the viewer's position in synchronization with the display-start of the stereoscopic video, and after that, the viewing area does not follow the viewer's position. Therefore, the viewing area does not move even when a third person moves in front of the liquid crystal panel 1, and the viewer can comfortably stereoscopically view the video.

Further, since the viewer normally operates the remote controller 20 while viewing the video, the viewer's position can be appropriately detected by detecting the display-start of the stereoscopic video using the infrared signal from the remote controller 20.

### Second Embodiment

The foregoing first embodiment was one in which a viewing area is set at an actual viewer's position at the display-start of stereoscopic video. On the other hand, a second embodiment is one in which a viewing area of the previous time of displaying stereoscopic video is stored, and the stored viewing area is set again at the next time of displaying stereoscopic video. In the following embodiment, differences from the first embodiment will be mainly described.

FIG. 8 is a flowchart showing an example of processing operations of the controller 10 of the video display apparatus 100 according to the second embodiment.

At the time of finishing displaying stereoscopic video (Step S21), the viewing area information calculator 14 stores a control parameter at that time (Step S22). Finishing the display of stereoscopic video means, for example, the time when the power of the video display apparatus 100 is turned off, the time when the 3D key 27 of the remote controller 20 is pushed down to switch the display from the stereoscopic display to the two-dimensional display, the time when a video signal is switched from a three-dimensional video signal to a two-dimensional video signal, or some other time. Further, the control parameter stored at this time may be one calculated by the auto tracking mode, or may be one calculated by the manual tracking mode as in the first embodiment. Moreover, it may be one calculated by another technique.

Subsequently, when the viewing area information calculator 14 detects the display-start of the stereoscopic video (Step S23: YES), the image adjuster 15 adjusts a parallax image signal according to the control parameter stored at Step S22 (Step S24). Thereby, the viewing area is set depending on the viewer's position. The set viewing area is kept in the same position until receipt of a direction to adjust the viewing area from the viewer.

As described above, in the second embodiment, the viewing area of the previous time of display-end of the stereoscopic video is set at the display-start of the stereoscopic video. Therefore, it is unnecessary to detect a viewer's position or newly calculate a control parameter at restarting displaying the stereoscopic video, thereby rapidly setting of viewing area.

It is considered that the viewer often views the video display apparatus 100 from a fixed position where a sofa or the like is placed. Accordingly, even when the viewing area of the previous time of display-end of the stereoscopic video is set without detecting a viewer's position, a viewing area can be set in the viewer's position in many cases.

Further, the present embodiment is particularly useful in a case of reproducing video signals in which both of a two-dimensional video signal and a three-dimensional video signal are mixed and they are high-frequently alternatively switched, as slide show display of photographs. That is, if a viewing area was newly set every time the signal is switched from the two-dimensional video signal to the three-dimensional video signal, the viewing area would be different every time or the setting of the viewing area would take time every time. On the other hand, in the present embodiment, a fixed viewing area can be rapidly set because the control parameter stored in the viewing area information calculator 14 is used.

In addition, it may be made selectable by the viewer whether to detect the viewer's position and set the viewing area as described in the first embodiment or to set the viewing area of the previous time of display of the stereoscopic video as described in the second embodiment.

### Third Embodiment

The foregoing first and second embodiments were ones in which the viewing area is controlled with timing when the display of the stereoscopic video is started. Even when the viewing area is set at the display-start of the stereoscopic video, the viewer does not necessarily keep viewing the video while staying still in a fixed position, but the viewer may move. On the manual tracking mode, the viewing area does not follow the viewer's position, and thus, the viewer may become unable to stereoscopically view the video when the viewer moves. Therefore, a third embodiment is one in which a viewing area is controlled with timing when the viewer pushes down the tracking key 28 of the remote controller 20 during displaying stereoscopic video.

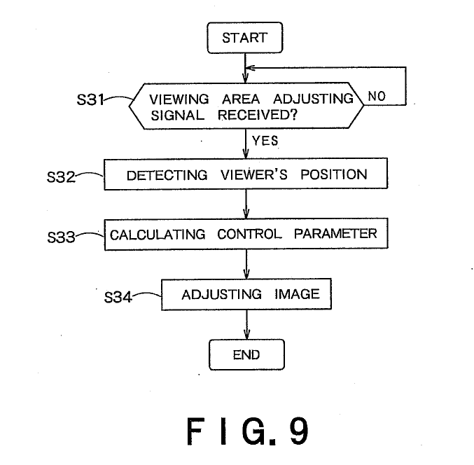

FIG. 9 is a flowchart showing an example of processing operations of the controller 10 of the video display apparatus 100 according to the third embodiment.

First, when the viewer pushes down the tracking key (signal generating module) 28 of the remote controller 20 during displaying the stereoscopic video, an infrared viewing area adjusting signal is generated, and transmitted to the light receiver 4 of the video display apparatus 100. When the light receiver 4 receives the viewing area adjusting signal (Step S31: YES), the viewer position detector 13 detects the viewer's position by using the video taken by the camera 3 (Step S32). The viewing area information calculator 14 calculates a control parameter such that the viewing area is set at the detected viewer's position (Step S33). Then, the image adjuster 15 adjusts the parallax image signals according to the control parameter (Step S34), and a parallax image corresponding to the adjusted parallax image signals is displayed on the liquid crystal panel 1.

Thereby, the viewing area is set at the viewer's position, and thus, the viewer can stereoscopically view the parallax image displayed on the liquid crystal panel 1 via the lenticular lens 2. On the manual tracking mode, the set viewing area is kept in the same position until receipt of a direction to adjust the viewing area from the viewer. The direction to adjust the viewing area means cases, for example, a case where the viewer pushes down the tracking key 28 again, a case where the viewer pushes down the 3D key 27 as described in the first and second embodiments, and so on.

As described above, in the third embodiment, the viewer's position is detected with timing when the viewer pushes down the tracking key 28 of the remote controller 20, and the viewing area is controlled. Since the timing for setting the viewing area can be directed by the viewer, the viewing area can be appropriately set again even when the viewer moves during viewing the stereoscopic video. Further, since the viewer normally operates the remote controller 20 while viewing the video, the viewer's position can be appropriately detected by transmitting the viewing area adjusting signal from the remote controller 20. Moreover, after setting again the viewing area, the set viewing area does not follow the viewer's position. Therefore, the viewing area does not move even when a third person moves in front of the liquid crystal panel 1, and the viewer can comfortably stereoscopically view the video.

It is to be noted that the tracking key 28 should not necessarily be provided on the remote controller 20, and in a case where the video display apparatus 100 is a tablet terminal or in some other case, a button or the like (signal generating module) corresponding to the tracking key 28 may be provided in the video display apparatus 100, or the tracking key 28 may be displayed on the liquid crystal panel 1 in the case of the video display apparatus 100 having a touch panel function.

### Fourth Embodiment

As described above, controlling the viewing area requires detection of the viewer's position, calculation of the control parameter and adjustment of the image. The adjustment of the image does not take so long time, whereas the detection of the viewer's position and the calculation of the control parameter may take long time. In particular, as described using FIG. 4, calculating the control parameter requires search for an optimal viewing area among predetermined viewing areas.

For this reason, a fourth embodiment is one in which, a control parameter is constantly calculated even during displaying two-dimensional video, and a viewing area can be rapidly set at timing for switching from the two-dimensional video to stereoscopic video (e.g., Step 11 of FIG. 7).

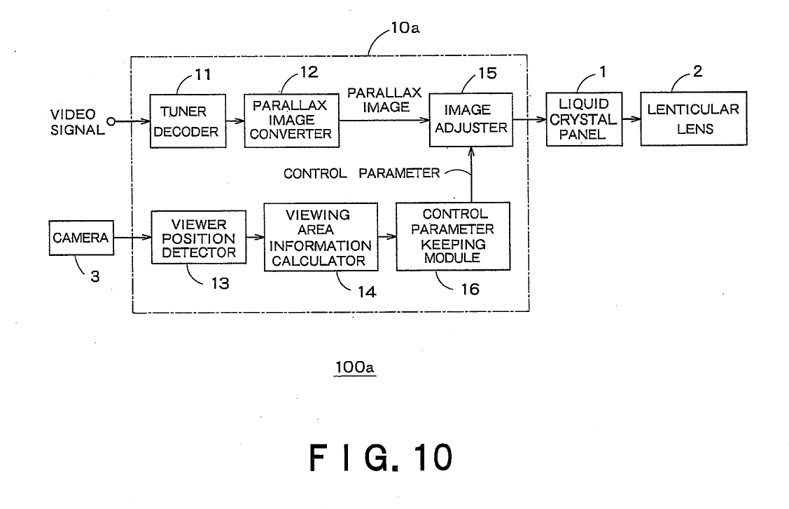

FIG. 10 is a block diagram showing a schematic configuration of a video display apparatus 100a according to the fourth embodiment. In FIG. 10, components in common with those in FIG. 2 are provided with the same numerals. A controller 10a of the video display apparatus 100a in FIG. 10 further has a control parameter keeping module 16. The control parameter keeping module 16 keeps the control parameter calculated by the viewing area information calculator 14.

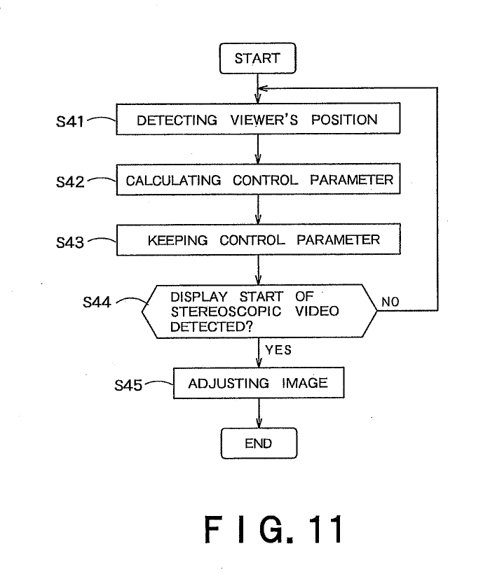

FIG. 11 is a flowchart showing an example of processing operations of the controller 10a of the video display apparatus 100a according to the fourth embodiment. In the figure, it is assumed that two-dimensional video is first displayed on the liquid crystal panel 1.

Even during displaying the two-dimensional video, the viewer position detector 13 detects the viewer's position by using video taken by the camera 3 (Step S41). Then, the viewing area information calculator 14 calculates a control parameter so as to set the viewing area in the detected viewer's position (Step S42). This control parameter is kept in the control parameter keeping module 16 (Step S43).

Here, when the light receiver 4 receives an infrared signal indicating that the viewer has pushed down the 3D key 27 of the remote controller 20 or when a video signal is switched from a two-dimensional video signal to a three-dimensional video signal, and thus, the controller 10a detects the display-start of the stereoscopic video (Step S44: YES), the image adjuster 15 adjusts the parallax image signal according to the control parameter kept in the control parameter keeping module 16 (Step S45), and a parallax image corresponding to the adjusted parallax image signal is displayed on the liquid crystal panel 1. Since the processing to be performed after the switch to the stereoscopic video is only the image adjustment (Step S45), an appropriate viewing area can be rapidly set.

On the other hand, when the display is not switched to the stereoscopic video and continued to be the two-dimensional video (Step S44: NO), for example, the control 10a repeats the processing of Steps S41 to S43 on the background with fixed intervals, to update the control parameter kept in the control parameter keeping module 16.

As described above, in the fourth embodiment, the control parameter is calculated and kept even during not-display of the stereoscopic video. Therefore, an appropriate viewing area can be rapidly set at the display-start of the stereoscopic video.

### Fifth Embodiment

A fifth embodiment is a modification of the foregoing fourth embodiment. Although the fourth embodiment was one in which the control parameter was calculated and kept during displaying two-dimensional video, the fifth embodiment is one in which a viewer's position is detected and kept during display of two-dimensional video.

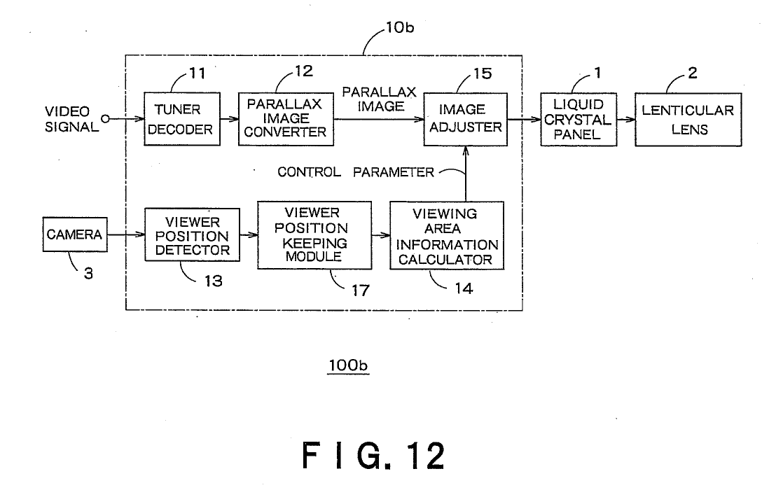

FIG. 12 is a block diagram showing a schematic configuration of a video display apparatus 100b according to the fifth embodiment. In FIG. 12, components in common with those in FIG. 2 are provided with the same numerals. A controller 10b of the video display apparatus 100b in FIG. 12 further has a viewer position keeping module 17. The viewer position keeping module 17 keeps the viewer position detected by the viewer position detector 13.

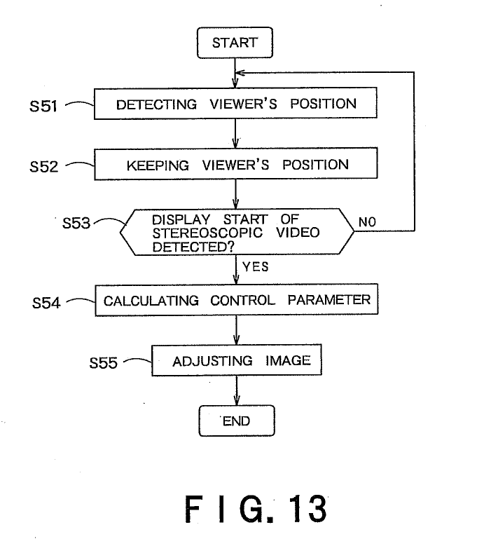

FIG. 13 is a flowchart showing an example of processing operations of the controller 10b of the video display apparatus 100b according to the fifth embodiment. In the figure, it is assumed that two-dimensional video is first displayed on the liquid crystal panel 1.

Even during displaying the two-dimensional video, the viewer position detector 13 detects the viewer's position by using video taken by the camera 3 (Step S51). This viewer's position is kept in the viewer position keeping module 17 (Step S52).

Here, when the light receiver 4 receives an infrared signal indicating that the viewer has pushed down the 3D key 27 of the remote controller 20 or when a video signal is switched from a two-dimensional video signal to a three-dimensional video signal, and thus, the controller 10b detects the display-start of the stereoscopic video (Step S53: YES), the viewing area information calculator 14 calculates the control parameter such that the viewing area is set at the viewer position kept in the viewer position keeping module 17 (Step S54).

The image adjuster 15 then adjusts the parallax image signal according to the calculated control parameter (Step S55), and parallax images corresponding to the adjusted parallax image signal is displayed on the liquid crystal panel 1. Since the processing to be performed after the switch to the stereoscopic video are only the calculation of the control parameter (Step S54) and the image adjustment (Step S55), an appropriate viewing area can be rapidly set as compared with the case of detecting the viewer's position after the display start of the stereoscopic video.

On the other hand, when the display is not switched to the stereoscopic video and continues to be the two-dimensional video (Step S54: NO), for example, the control 10b repeats the processing of Steps S51, S52 on the background with fixed intervals, to update the viewer's position kept in the viewer position keeping module 17.

As described above, in the fifth embodiment, the viewer's position is detected and kept even during not-display of the stereoscopic video. Therefore, an appropriate viewing area can be rapidly set at the display-start of the stereoscopic video.

### Sixth Embodiment

The viewer position detector 13 cannot always detect the viewer's position. The viewer position detector 13 may not be able to recognize the viewer, for example, in a case where a viewing field of the camera 3 is hindered by a certain obstacle, where the viewer's face is located outside a video-taking range of the camera 3, or where the viewer's face is difficult to detect due to the viewer wearing a mask or looking down even with the face located within the video-taking range of the camera 3, or in some other case. In this case, the viewing information calculator 14 cannot calculate a control parameter based on the viewer's position. Further, it may happen that a control parameter cannot be calculated due to a failure of the viewing area information calculator 14, or the like.

Sixth to eighth embodiments described hereinafter relate to processing operations in a case where a control parameter cannot be calculated.

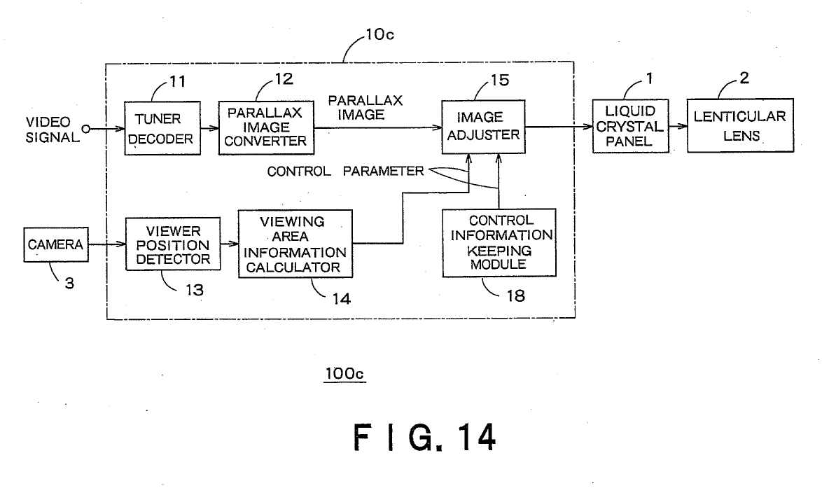

FIG. 14 is a block diagram showing a schematic configuration of a video display apparatus 100c according to a sixth embodiment. In FIG. 14, components in common with those in FIG. 2 are provided with the same numerals. A controller 10c of the video display apparatus 100c in FIG. 14 further has a control information keeping module 18. The control information keeping module 18 keeps, as a so-called default value, a control parameter calculated such that a viewing area is set in a predetermined area in advance.

The predetermined area is, for example, set such that it is in front of the liquid crystal panel 1 and a distance between the liquid crystal panel 1 and the viewer is 3H (H is a height of the liquid crystal panel 1). This is because the video display apparatus is often designed taking into consideration that the viewer views the liquid crystal panel 1 in this position. Alternatively, an area where the viewer normally views video may be set.

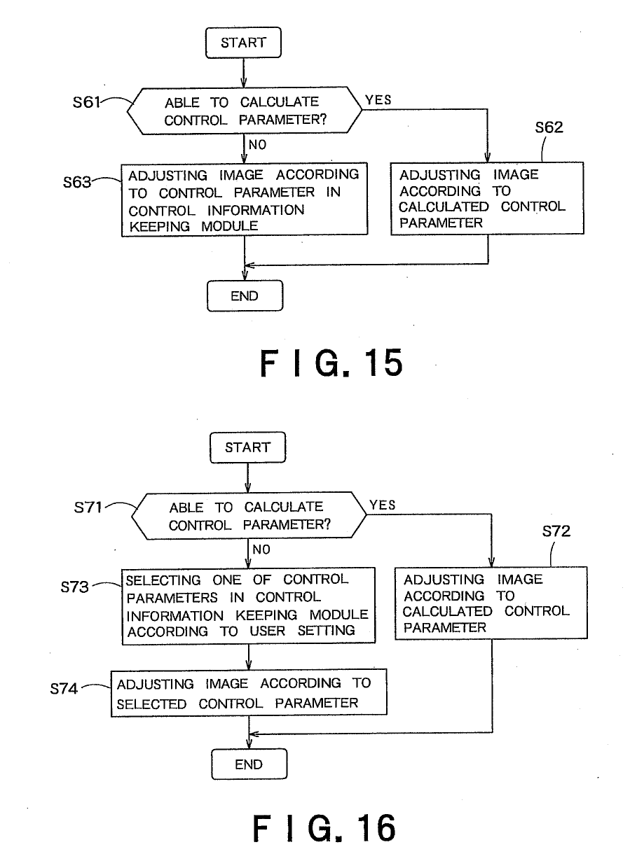

FIG. 15 is a flowchart showing an example of processing operations by the controller 10c of the video display apparatus 100c according to the sixth embodiment.

When the viewing area information calculator 14 can calculate a control parameter with timing for controlling the viewing area (Step S61: YES), the image adjuster 15 performs image adjustment according to the calculated control parameter (first control parameter) (Step S62). Here, the timing for controlling the viewing area is, for example, timing for controlling the viewing area in Step S11 of FIG. 8, Step S24 of FIG. 9, Step S31 of FIG. 10, on the auto tracking mode, and the like.

On the other hand, when the viewing area information calculator 14 cannot calculate the control parameter due to the above reason or the like (Step S61: NO), the image adjuster 15 performs image adjustment for setting the viewing area according to the control parameter (second control parameter) kept in the control information keeping module 18 (Step S63).

As described above, in the sixth embodiment, the control parameter for setting the viewing area in the predetermined area is kept in the control information keeping module 18 in advance. For this reason, even if it is impossible to calculate the control parameter, such as a case where the viewer cannot be detected, the viewing area can be set. In particular, by setting the control parameter kept in the control information keeping module 18 based on the height of the liquid crystal panel 1 or by setting the same based on a normal viewing position of the viewer, an appropriate viewing area can be set.

### Seventh Embodiment

A seventh embodiment is one in which a plurality of control parameters are kept in the control information keeping module 18 and one of them is selected according to the user's setting and used for setting a viewing area. It is to be noted that a schematic configuration of the video display unit of the present embodiment is not described since being almost the same as that in FIG. 15

One of the plurality of control parameters is, for example, a control parameter for setting the viewing area in an area where the distance between the liquid crystal panel 1 and the viewer is 3H, with viewing the video display apparatus 100c at home taken into consideration. Another one is, for example, a control parameter for setting the viewing area in an area where the distance is longer than the above distance, with displaying the video display apparatus 100c at the store taken into consideration. The user sets which one is to be used among the plurality of control parameters in advance.

FIG. 16 is a flowchart showing an example of processing operations of the controller 10c of the video display apparatus 100c according to the seventh embodiment. The processing operation in a case where the viewing area information calculator 14 can calculate the control parameter is similar to that in the sixth embodiment (Step S71: YES, S72).

On the other hand, in a case where the viewing area information calculator 14 cannot calculate the control parameter (Step S71: NO), the image adjuster 15 selects one of the plurality of parameters kept in the control information keeping module 18 according to the user's setting (Step S73). The image adjuster 15 then performs image adjustment for setting the viewing area according to the selected control parameter (Step S74).

As described above, in the seventh embodiment, since one among the plurality of control parameters kept in the control information keeping module 18 is selected, the viewing area can be appropriately set according to the user's setting even when the control parameter cannot be calculated.

### Eighth Embodiment

An eighth embodiment is one in which a plurality of control parameters is kept in the control information keeping module 18 and one of them is automatically selected according to displayed contents, so as to be used for setting a viewing area. It is to be noted that a schematic configuration of the video display unit of the present embodiment is not described since being almost the same as that in FIG. 15

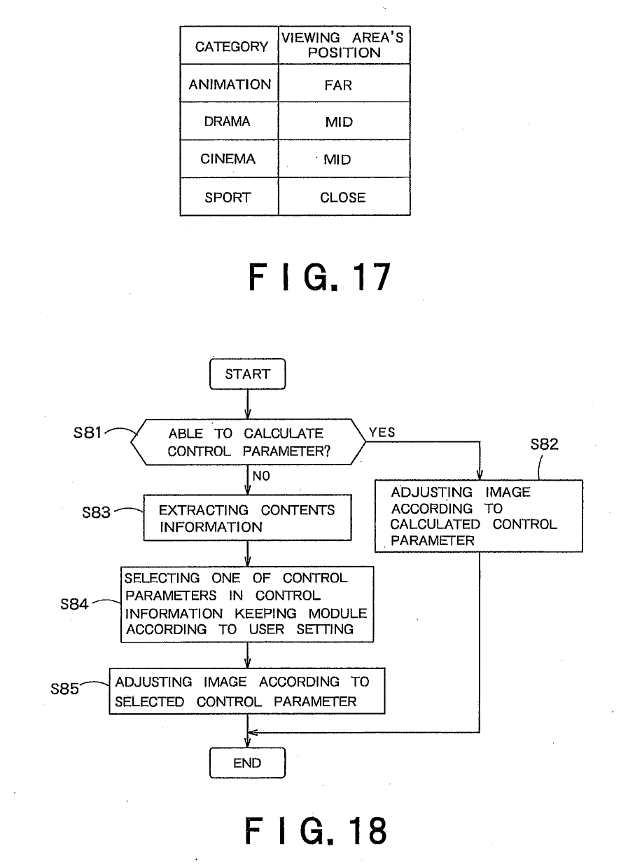

FIG. 17 is a diagram showing an example of the relation between a category of contents and a position of the viewing area, kept in the control information keeping module 18. For example, when a category of displayed contents is an animation, it is likely to be viewed by a child, and it is assumed in this case that the viewer is distant from the liquid crystal panel 1. Therefore, such a control parameter is kept as to make the viewing area set in a position distant from the liquid crystal panel 1. Further, when the category is a sport, exciting contents are likely to be viewed from a position near the liquid crystal panel 1. For this reason, such a control parameter is kept as to make the viewing area set in a position near the liquid crystal panel 1. When the category is a drama or a cinema, such a control parameter is kept as to make the viewing area set in a position to a degree midway between the animation and the sport.

FIG. 17 is just an example, and another category may be set, or a viewing time and the like may further be considered as contents information.

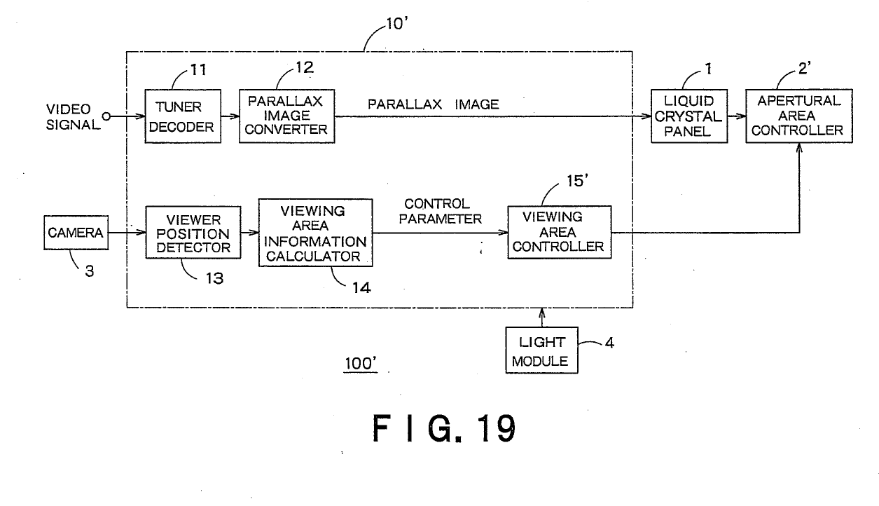

FIG. 18 is a flowchart showing an example of processing operations of the controller 10c of the video display apparatus 100c according to the eighth embodiment. The processing operation in a case where the viewing area information calculator 14 can calculate the control parameter is similar to that in the sixth embodiment (Step S81: YES, S82).

On the other hand, if the viewing area information calculator 14 cannot calculate viewing area information (Step S81: NO), the tuner decoder 11 acquires an electronic program guide from data broadcasting superimposed on a broadcast wave, and extracts contents information of the contents that are displayed on the liquid crystal panel 1 based on this guide (Step S83). Alternatively, contents information may be acquired via the Internet.

The image adjuster 15 then selects one of the plurality of control parameters kept in the control information keeping module 18, according to a category of the contents (Step S84). For example, when the category is an animation, the image adjuster 15 selects a control parameter for setting the viewing area in a position near the liquid crystal panel 1 (FIG. 17). The image adjuster 15 then performs image adjustment for setting the viewing area according to the selected control parameter (Step S85).

As described above, in the eighth embodiment, since the control parameters predetermined depending on the contents information are kept in the control information keeping module 18, the viewing area can be automatically set in an appropriate manner according to contents.

As described in each of the above embodiments, the video display apparatus can appropriately set the viewing area.

In addition, although, in each of the embodiments, examples of the video display apparatus were shown where a viewing area is controlled by using the lenticular lens 2 and shifting the parallax images, the viewing area may be controlled by another technique. For example, a parallax barrier may be provided as the apertural area controller in place of the lenticular lens 2. Further, FIG. 19 is a block diagram showing a schematic configuration of a video display apparatus 100′ as a modification of FIG. 2. As shown in the figure, the processing of shifting the parallax image may not be performed, and a viewing area controller 15′ may be provided inside a controller 10′, to control an apertural area controller 2′. In this case, the distance between the liquid crystal panel 1 and the apertural area controller 2′, a horizontal shift length between the liquid crystal panel 1 and the apertural controller 2′, or the like is regarded as a control parameter, and an output direction of a parallax image displayed on the liquid crystal panel 1 is controlled, thereby controlling the viewing area. The video display apparatus in FIG. 19 may be applied to each of the embodiments.

At least a part of the video processing apparatus explained in the above embodiments can be formed of hardware or software. When the video processing apparatus is partially formed of the software, it is possible to store a program implementing at least a partial function of the video processing apparatus in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video processing apparatus can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A video processing apparatus comprising:
a viewer position detector configured to detect a position of a viewer in an image taken by a camera;
a viewing area information calculator configured to calculate a control parameter for setting a viewing area in which a plurality of parallax images displayed on a display are viewed as a stereoscopic image, at an area depending on the position of the viewer; and
a viewing area controller configured to set the viewing area according to the control parameter in synchronization with a start of displaying a stereoscopic image, the viewing area controller further configured to keep the set viewing area until receiving an indication for adjusting the viewing area.

2. The apparatus of claim 1, wherein:
the viewing area information calculator is configured to store the control parameter at an end of displaying a stereoscopic image, and
the viewing area controller is configured to set the viewing area according to the control parameter for setting the viewing area at the area depending on the position of the viewer or according to the control parameter at the end of displaying the stereoscopic image.

3. The apparatus of claim 2 further comprising:
a receiver configured to decode an input video signal; and
a parallax image converter configured to generate the plurality of parallax images based on the decoded input video signal,
wherein the viewing area controller is configured to set the viewing area according to the control parameter at the end of displaying the stereoscopic image when the input video signal comprises both of a two dimensional signal and a stereoscopic signal.

4. The apparatus of claim 1, wherein the viewing area controller is configured to detect the start of displaying the stereoscopic image by receiving a signal indicative of the start of displaying the stereoscopic image from a remote controller.

5. The apparatus of claim 1 further comprising:
a receiver configured to decode an input video signal; and
a parallax image converter configured to generate the plurality of parallax images based on the decoded input video signal,
wherein the viewing area controller is configured to detect the start of displaying the stereoscopic image based on a change of the input video signal from a two dimensional signal to a stereoscopic signal.

6. The apparatus of claim 1, wherein the viewing area controller is configured to adjust a display position of the plurality of parallax images according to the control parameter; or control an output direction of the plurality of parallax images according to the control parameter.

7. The apparatus of claim 1 further comprising:
a display configured to display the plurality of parallax images; and
an apertural area controller configured to output the plurality of parallax images toward a given direction.

8. The apparatus of claim 1 further comprising:
a receiver configured to decode an input video signal; and
a parallax image converter configured to generate the plurality of parallax images based on the decoded input video signal.

9. The apparatus of claim 8, wherein the receiver is configured to receive and tune a broadcast wave, and to decode the tuned broadcast wave.

10. The apparatus of claim 1 further comprising a camera configured to take an area to detect the position of the viewer.

11. A video processing apparatus comprising:
a viewer position detector configured to detect a position of a viewer in an image taken by a camera;
a viewing area information calculator configured to calculate a control parameter for setting a viewing area in which a plurality of parallax images displayed on a display are viewed as a stereoscopic image, at an area depending on the position of the viewer; and
a viewing area controller configured to set the viewing area according to the control parameter,
wherein the viewing area information calculator is configured to store the control parameter at an end of displaying a stereoscopic image, and
the viewing area controller is configured to set the viewing area according to the control parameter at the end of displaying the stereoscopic image in synchronization with a start of displaying a stereoscopic image, the viewing area controller further configured to keep the set viewing area until receiving an indication for adjusting the viewing area.

12. The apparatus of claim 11, wherein the viewing area controller is configured to detect the start of displaying the stereoscopic image by receiving a signal indicative of the start of displaying the stereoscopic image from a remote controller.

13. The apparatus of claim 11 further comprising:
a receiver configured to decode an input video signal; and
a parallax image converter configured to generate the plurality of parallax images based on the decoded input video signal,
wherein the viewing area controller is configured to detect the start of displaying the stereoscopic image based on a change of the input video signal from a two dimensional signal to a stereoscopic signal.

14. The apparatus of claim 11, wherein the viewing area controller is configured to adjust a display position of the plurality of parallax images according to the control parameter or control an output direction of the plurality of parallax images according to the control parameter.

15. The apparatus of claim 11 further comprising:
a display configured to display the plurality of parallax images; and
an apertural area controller configured to output the plurality of parallax images toward a given direction.

16. The apparatus of claim 11 further comprising:
a receiver configured to decode an input video signal; and
a parallax image converter configured to generate the plurality of parallax images based on the decoded input video signal.

17. The apparatus of claim 16, wherein the receiver is configured to receive and tune a broadcast wave, and to decode the tuned broadcast wave.

18. The apparatus of claim 11 further comprising a camera configured to take an area to detect the position of the viewer.

19. A video processing method comprising:
detecting a position of a viewer in an image taken by a camera;
calculating a control parameter for setting a viewing area in which a plurality of parallax images displayed on a display are viewed as a stereoscopic image, wherein the viewing area depends on the position of the viewer; and
setting the viewing area according to the control parameter in synchronization with a start of displaying a stereoscopic image, and keeping the set viewing area until receiving an indication for adjusting the viewing area.

20. The method of claim 19 further comprising storing the control parameter at an end of displaying a stereoscopic image,
wherein upon setting the viewing area, the viewing area is set according to the control parameter for setting the viewing area at the area depending on the position of the viewer or according to the control parameter at the end of displaying the stereoscopic image.

21. The method of claim 20 further comprising:
decoding an input video signal; and
generating the plurality of parallax images based on the decoded input video signal,
wherein upon setting the viewing area, the viewing area is set according to the control parameter at the end of displaying the stereoscopic image when the input video signal comprises a two dimensional signal and a stereoscopic signal.

22. The method of claim 19 further comprising receiving a signal indicative of the start of displaying the stereoscopic image from a remote controller,
wherein upon setting the viewing area, the start of displaying the stereoscopic image is detected according to the signal.

23. The method of claim 19 further comprising:
decoding an input video signal; and
generating the plurality of parallax images based on the decoded input video signal,
wherein upon setting the viewing area, the start of displaying the stereoscopic image is detected based on a change of the input video signal from a two dimensional signal to a stereoscopic signal.

24. The method of claim 19, wherein upon setting the viewing area,
a display position of the plurality of parallax images is adjusted according to the control parameter; or
an output direction of the plurality of parallax images is controlled according to the control parameter.

25. The method of claim 19 further comprising:
decoding an input video signal; and
generating the plurality of parallax images based on the decoded input video signal.

26. The method of claim 25, wherein upon decoding the video signal, a broadcast wave is received, tuned, and decoded.

27. A video processing method comprising:
detecting a position of a viewer in an image taken by a camera;
calculating a control parameter for setting a viewing area in which a plurality of parallax images displayed on a display are viewed as a stereoscopic image, at an area depending on the position of the viewer;
setting the viewing area according to the control parameter; and
storing the control parameter at an end of displaying a stereoscopic image,
wherein upon setting the viewing area, the viewing area is set according to the control parameter at the end of displaying the stereoscopic image in synchronization with a start of displaying a stereoscopic image, and the set viewing area is kept until receiving an indication for adjusting the viewing area.

28. The method of claim 27 further comprising receiving a signal indicative of the start of displaying the stereoscopic image from a remote controller,
wherein upon setting the viewing area, the start of displaying the stereoscopic image is detected according to the signal.

29. The method of claim 27 further comprising:
decoding an input video signal; and
generating the plurality of parallax images based on the decoded input video signal,
wherein upon setting the viewing area, the start of displaying the stereoscopic image is detected based on a change of the input video signal from a two dimensional signal to a stereoscopic signal.

30. The method of claim 27, wherein upon setting the viewing area,
a display position of the plurality of parallax images is adjusted according to the control parameter; or
an output direction of the plurality of parallax images is controlled according to the control parameter.

31. The method of claim 27 further comprising:
decoding an input video signal; and
generating the plurality of parallax images based on the decoded input video signal.

32. The method of claim 31, wherein upon decoding the video signal, a broadcast wave is received, tuned, and decoded.
